(19) United States
(12) Patent Application Publication
(10) Pub. No.: US 2020/0147869 A1
(43) Pub. Date: May 14, 2020

(54) DETECTION OF CONTAMINANT IN ADDITIVE MANUFACTURING

(71) Applicant: AIRBUS OPERATIONS LIMITED, Bristol (GB)

(72) Inventor: Martin MUIR, Bristol (GB)

(21) Appl. No.: 16/675,732

(22) Filed: Nov. 6, 2019

(30) Foreign Application Priority Data
Nov. 9, 2018 (GB) 1818257.6

(51) Int. Cl. B29C 64/153; B29C 64/35; B29C 64/268; B29C 64/245; B29C 64/205

(52) U.S. Cl. CPC B29C 64/153; B29C 64/35; B33Y 10/00; B29C 64/245; B29C 64/205; B29C 64/268

(57) ABSTRACT

To additively manufacturing an object, a powder bed is built by depositing a series of layers of powder. For at least some of the layers, before a next layer in the series is deposited: the powder of the layer in inspected by performing an x-ray scan of at least some of the powder of the layer to detect whether or not a contaminant is present in the powder of the layer, and a selected part of the powder of the layer is fused in accordance with a three-dimensional model of the object.

### RELATED APPLICATION

This application claims priority to United Kingdom Patent Application GB 1818257.6, filed Nov. 9, 2018, the entirety of which is incorporated by reference.

### FIELD OF THE INVENTION

The present invention relates to a method of additively manufacturing an object, and associated apparatus.

### BACKGROUND OF THE INVENTION

In US2018/0126670A1 a method for inspection of additive manufactured parts and monitoring operational performance of an additive manufacturing apparatus is provided. The method includes a step of obtaining, in real-time during an additively manufactured build process, a backscatter x-ray scan of an area of a build platform. The build platform is configured for supporting at least one part during the build process. An evaluating step evaluates, by a processor, the backscatter x-ray scan. A determining step determines, based on the evaluating, whether an operational flaw with the additive manufacturing apparatus has occurred or a defect in the at least one part has occurred. A backscatter x-ray system has an emitter that emits x-rays and a detector that receives backscattered x-rays. The emitter and detector are located on a movable support located above the build platform, and the movable support raises and lowers the emitter and detector with respect to the build platform.

### SUMMARY OF THE INVENTION

According to an aspect of the invention, there is provided a method of additively manufacturing an object, the method comprising: building a powder bed by depositing a series of layers of powder; and for at least some of the layers, before a next layer in the series is deposited: inspecting the powder of the layer by performing an x-ray scan of at least some of the powder of the layer to detect whether or not a contaminant is present in the powder of the layer, and selectively fusing a selected part of the powder of the layer in accordance with a three-dimensional model of the object.

According to a further aspect of the invention, there is provided apparatus for additively manufacturing an object, the apparatus comprising: a powder bed build system arranged to build a powder bed by depositing a series of layers of powder; an x-ray inspection system arranged to perform an x-ray scan of at least some of the powder of at least some of the layers to detect whether or not a contaminant is present in the powder of the layer; and a powder-fusion system arranged to selectively fuse part of the powder of at least some of the layers in accordance with a three-dimensional model of the object.

In US2018/0126670A1 the x-ray scan determines whether a defect in an object has occurred, but in the present invention an x-ray scan of the unfused powder is carried out so a contaminant can be detected before it is incorporated into the object as a defect such as a high density inclusion. That is to say, the selected part of the powder is fused after it has been inspected to detect whether or not a contaminant is present in the selected part of the powder.

Typically if no contaminant is detected in the selected part of the powder of the layer, then the selected part of the powder of the layer is fused in accordance with the three-dimensional model of the object.

If a contaminant is detected, then optionally the contaminant is not incorporated into the object. In this case the method is typically stopped or interrupted before the contaminant is incorporated into the object by fusing powder to the contaminant.

If a contaminant is detected, then optionally the contaminant is analysed to determine whether it is acceptable. If the contaminant is acceptable then the contaminant is incorporated into the object by fusing powder to the contaminant, and if the contaminant is not acceptable then the contaminant is not incorporated into the object.

If a contaminant is detected, then optionally the contaminant is analysed to determine whether a location of the contaminant is acceptable. If the location of the contaminant is acceptable then the contaminant is incorporated into the object by fusing powder to the contaminant, and if the location of the contaminant is not acceptable then the contaminant is not incorporated into the object.

If a contaminant is detected, then optionally data about the contaminant, for instance a size, location, density or material of the contaminant, is logged.

If a contaminant is detected, then optionally the contaminant is removed in post-processing after it has been incorporated into the object.

Typically inspecting the powder comprises directing incident x-rays onto at least some of the powder of the layer to generate scattered or reflected x-rays, and analysing the scattered or reflected x-rays to detect whether or not a contaminant is present.

Typically inspecting the powder comprises directing incident x-rays onto at least some of the powder of the layer at an angle of incidence, and analysing x-rays reflected from the powder of the layer at an angle of reflection which is equal and opposite to the angle of incidence to detect whether or not a contaminant is present.

Typically inspecting the powder comprises directing incident x-rays onto at least some of the powder of the layer from an x-ray source to generate scattered or reflected x-rays, receiving the scattered or reflected x-rays from the powder of the layer at an x-ray detector, and analysing the scattered or reflected x-rays received at the x-ray detector to detect whether or not a contaminant is present.

If a contaminant is present then the scattered or reflected x-rays can be analysed to detect the size, location, density or material of the contaminant.

An intensity of the scattered or reflected x-rays received at the x-ray detector may be analysed to detect whether or not a contaminant is present. Alternatively, other parameters may be analysed such as frequency.

The x-ray source and/or the x-ray detector may be positioned above the powder bed as in US2018/0126670A1 for example, but more preferably the x-ray source is positioned on a first side of the powder bed, the x-ray detector is positioned on a second side of the powder bed opposite the first side, and neither the x-ray source nor the x-ray detector is positioned above the powder bed. Optionally a horizontal spacing between the x-ray source and the x-ray detector is greater than a width of the powder bed.

The x-ray source and/or the x-ray detector may be stationary during the x-ray scan, but more typically the x-ray source and/or the x-ray detector move during the x-ray scan. For instance the x-ray source and/or the x-ray detector may translate during the x-ray scan; and/or the x-ray source and/or the x-ray detector may rotate during the x-ray scan.

The x-ray scan may be used to scan the entire powder layer, including parts which are not due to be fused. More typically inspecting the powder of the layer comprises performing an x-ray scan of the selected part of the powder of the layer in accordance with the three-dimensional model of the object to detect whether or not a contaminant is present in the selected part powder of the layer before it is fused, wherein unselected parts of the powder of the layer are not x-ray scanned.

Typically the x-ray scan is performed for the layer over an inspection period, and fusing the part of the powder of the layer is performed over a fusion period which is partially concurrent with the inspection period. This results in a quicker build process since it is not necessary for the inspection period to finish before starting the fusion period.

The part of the powder may be fused by scanning a laser beam across the powder of the layer. The fusion may be caused by a heating process, which may or may not melt the powder. Instead of using a laser beam, the powder may be fused by another type of energy beam such as an electron beam, or by direct contact with a heating head.

The powder may be a metal powder, such as a titanium alloy. Alternatively the powder may be a thermoplastic powder or any other powdered material suitable for a powder-bed fusion process.

A further aspect of the invention provides apparatus for additively manufacturing an object, the apparatus comprising: a powder bed build system comprising a build table, the powder bed build system arranged to build a powder bed on the build table by depositing a series of layers of powder; a powder-fusion system arranged to selectively fuse part of the powder of at least some of the layers in accordance with a three-dimensional model of the object; and an x-ray reflectrometry inspection system arranged to inspect the powder bed, the x-ray reflectrometry inspection system comprising an x-ray source arranged to direct incident x-rays onto the powder bed at an oblique angle of incidence to generate reflected x-rays, an x-ray detector positioned to receive the reflected x-rays from the powder bed at an oblique angle of reflection which is equal and opposite to the angle of incidence, and a processor arranged to analyse the reflected x-rays received at the x-ray detector, wherein the x-ray source is positioned on a first side of the build table, the x-ray detector is positioned on a second side of the build table opposite the first side, and neither the x-ray source nor the x-ray detector is positioned above the build table.

The processor may be arranged to analyse the reflected x-rays received at the x-ray detector to detect whether or not a contaminant is present in the powder.

The apparatus may further comprise a horizontal spacing between the x-ray source and the x-ray detector, wherein the horizontal spacing is greater than a width of the build table.

The powder bed build system may further comprise a build chamber bounded by first and second side walls, wherein the x-ray source is positioned in the first side wall and the x-ray detector is positioned in the second side wall. The build table may be mounted in a base of the build chamber.

The power bed build system may further comprises a build table actuator for lowering the build table.

### BRIEF DESCRIPTION OF THE DRAWINGS

Embodiments of the invention will now be described with reference to the accompanying drawings, in which:

FIG. 1 is a cross-sectional view of apparatus for additively manufacturing an object at the start of an inspection period of a powder layer;

FIG. 2 shows the apparatus part way through the inspection and fusion period for the layer;

FIG. 3 is an isometric view of the apparatus;

FIGS. 4a, 4b and 4c show scanning patterns of the x-ray beam and the laser beam;

FIG. 5 shows the laser beam lagging behind the x-ray beam by a smaller distance and time;

FIG. 6 shows a method of inspecting and fusing a layer;

FIG. 7 shows an alternative method of inspecting and fusing a layer; and

FIG. 8 shows a further alternative method of inspecting and fusing a layer.

### DETAILED DESCRIPTION OF EMBODIMENT(S)

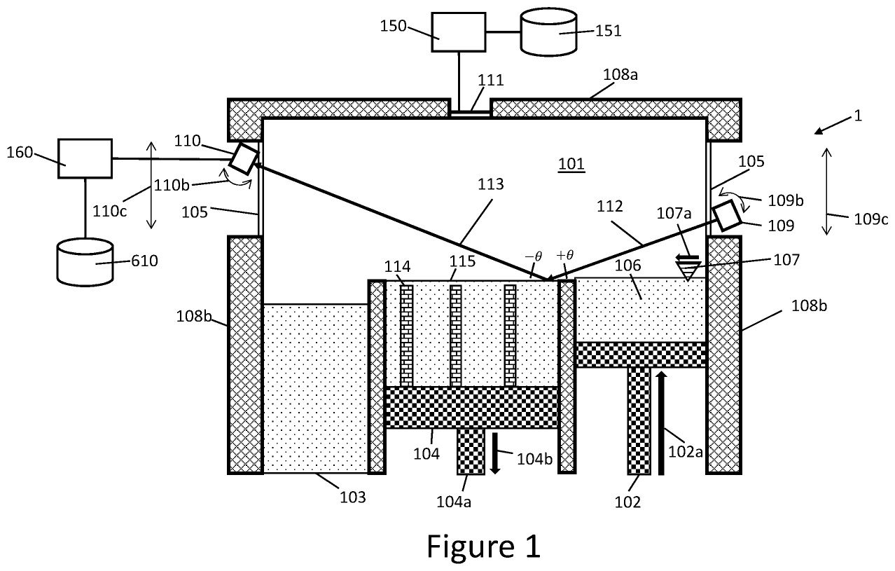

A powder bed fusion system for additively manufacturing an object is shown in FIGS. 1-3. The apparatus comprises a powder bed build system 1 arranged to build a powder bed by depositing a series of layers of powder. The powder bed build system 1 comprises a build chamber 101 bounded by an upper wall 108a and sides walls 108b. A build table 104 is mounted in the base of the build chamber.

A powder hopper on one side of the build table 104 contains metal powder 106, which is spread across the build table 104 by a recoater 107 to build up the series of layers of powder one-by-one. Overflowing powder is collected in a powder overflow hopper 103. Before a layer of powder has been spread across, the build table 104 is lowered by a build table actuator 104a as indicated by arrow 104b, to allow the layer of powder to be spread. To spread the layer of powder the recoater 107 pushes powder from the powder hopper over the build table 104, as indicated by arrow 107a. After a layer of powder has been spread across, the recoater 107 returns to its retracted position and the base of the hopper is lifted up the thickness of a single layer by an actuator 102 as indicated by arrow 102a.

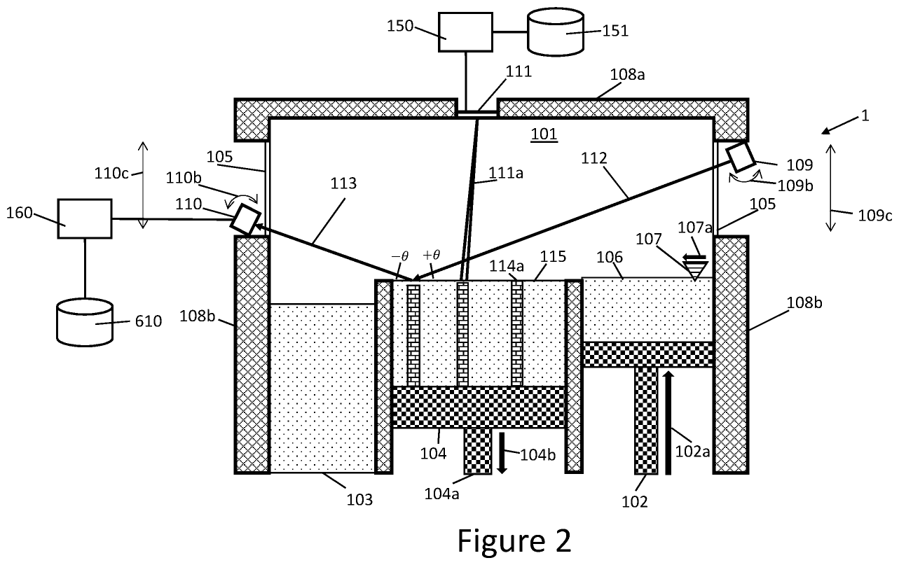

A powder-fusion system is arranged to selectively fuse part of the powder of at least some of the layers in accordance with a three-dimensional model of the object. The powder fusion system comprises a laser 111 which generates a laser beam 111a (FIG. 2) under the control of a laser controller 150. A memory 151 stores the three-dimensional model of the object in the form of Computer-Aided Design (CAD) data such as a .STL file. The laser controller 150 turns the laser beam 111a on and off so the current layer of powder is selectively fused (for instance by melting or sintering) to create a “slice” of the object guided by the .STL file. The fused powder fuses to the preceding layers as it cools.

FIG. 1 shows a layer of powder 115 which has just been deposited and not yet fused. In this case an array of six similar but unconnected objects 114 is being built, each object being associated with a respective .STL file.

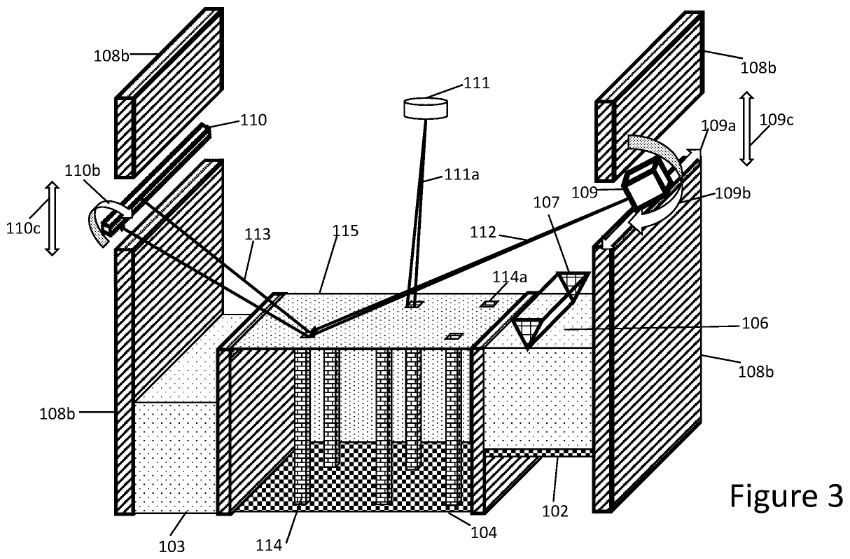

The fusion of the selected part(s) of the layer 115 is performed over a fusion period which has not yet started in FIG. 1. FIGS. 2 and 3 show a point in the fusion period at which two “islands” 114a of powder in the layer 115 have been fused (each island associated with a respective one of the six objects 114) and a third island is being heated by the laser beam 111a.

An x-ray reflectometry inspection system is arranged to perform an x-ray scan of at least some of the powder of each layer to detect whether or not a contaminant is present in the powder of the layer. The x-ray reflectometry inspection system comprises an x-ray source 109 arranged to direct incident x-rays 112 onto the powder of the layer 115 through a window 105 at an oblique angle of incidence +θ relative to a surface of the layer 115, to generate reflected x-rays 113 at an oblique angle of reflection −θ which is specular, in other words it is equal and opposite to the angle of incidence +θ. An x-ray detector 110 is arranged to receive the reflected x-rays 113 from the powder of the layer 115 through a window 105, and a processor 160 is arranged to analyse the reflected x-rays 113 received at the x-ray detector 110 to detect contaminants in the powder of the layer 115. This x-ray reflectometry process enables a thin powder layer 115 to be inspected sensitively and accurately.

The .STL file in the memory 151 is used to guide the x-ray beam 112 so the x-ray beam 112 and laser beam 111a follow the same predefined path, one after the other.

The processor 160 may detect a variety of different types of contaminant—a contaminant being any anomaly, such as a particle, which may be detrimental to the material performance of the object. Typically the powder 106 is produced from a block of an alloy such as Ti 6-4 which contains a mixture of titanium, aluminium and vanadium (for instance 90% titanium, 6% aluminium, 4% vanadium). Some of the powder particles may be pure metal (titanium, aluminium or vanadium) rather than an alloy; or an alloy with a percentage of each metal which differs from the required percentages of 90%, 6% and 4%. Such powder particles may be considered as a contaminant. Alternatively flakes or particles of high-density material such as steel may be present, and are also considered as a contaminant. The intensity of the reflected x-rays 113 will vary if there is a contaminant. For example a high density flake or particle will tend to absorb the x-rays more strongly than the Ti 6-4 powder so the intensity will reduce. Similarly pure titanium, aluminium or vanadium will reflect the x-rays more strongly or weakly so the intensity will change accordingly.

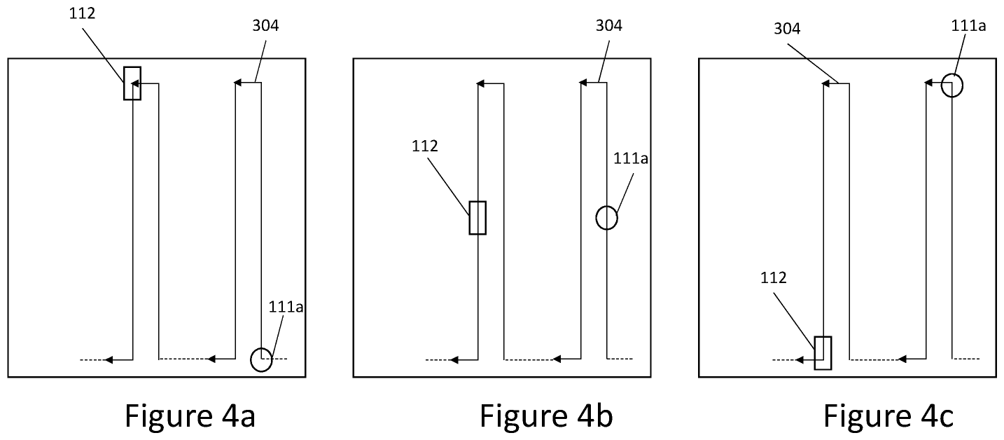

The x-ray scan of the layer 115 is performed over an inspection period which is partially concurrent with the fusion period. The inspection period has just started in FIG. 1 and the fusion period has not yet started. FIGS. 4a-c show the footprints of the x-ray beam 112 and laser beam 111a as they scan across the powder in a predefined raster path 304 at three different points in time. The x-ray beam 112 leads the laser beam 111a so that each area of the powder layer 115 is inspected before it can be fused by the laser beam 111a. The distance between the beams 112, 111a is chosen to avoid any interference with the x-ray scan caused by sputtering or x-ray emissions from the heated powder. This distance is at a minimum in FIG. 4b.

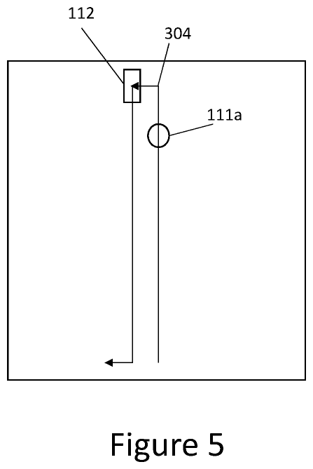

FIG. 5 shows a scanning pattern similar to FIG. 4 except the x-ray beam 112 leads the laser beam 111a by a shorter period of time (and hence the minimum distance between the beams 112, 111a is shorter). This results in more overlap between the inspection period and the fusion period, and hence a faster build process, but increases the risk of interference caused by sputtering or x-ray emissions from the heated powder. It also requires the processor 160 to detect and characterise contaminants more quickly before they are incorporated into the object.

As shown in FIGS. 1-3, the x-ray source 109 is positioned in a sidewall 108b on a first side of the powder bed, and the x-ray detector 110 is positioned in a sidewall 108b on a second side of the powder bed opposite the first side. This means that neither the x-ray source 109 nor the x-ray detector 110 is positioned above the powder bed, unlike the laser 111 which is positioned above the powder bed. Also, a horizontal spacing between the x-ray source 109 and the x-ray detector 110 is greater than the width of the powder bed.

This arrangement means that there is no interference between the x-ray reflectometry inspection system and the powder infusion system. In other words neither the x-ray source 109 nor the x-ray detector 110 obstructs the laser beam 111a, and the laser 111 does not obstruct either of the x-ray beams 112, 113. This lack of interference enables the powder layer 115 to be inspected and fused at the same time, rather than waiting for the inspection period for the whole layer to finish before starting the fusion period.

The laser beam 111a can pass through either of the x-ray beams 112,113 without interference.

The x-ray source 109 rotates as indicated by 109b to scan the x-ray beam 112 from one side to the other side, and as it does so it also moves up and down between the positions of FIG. 1 and FIG. 2, indicated by arrow 109c. The x-ray detector 110 also rotates as indicated by arrow 110b (to remain perpendicular to the reflected x-ray beam 113) and moves vertically as indicated by arrow 110c as required to receive the reflected x-ray beam 113. The x-ray source 109 also translates horizontally as indicated by arrow 109a along the build platform, out of the plane of FIGS. 1 and 2, to complete the scan of the layer. In this case the x-ray detector 110 is a plate which extends along the full length of the powder bed so does not need to be translated horizontally. If a smaller x-ray detector is used then horizontal motion may be required.

In the case of FIGS. 1-3 each layer of the powder bed is x-ray inspected and fused to form part of each object. Other object shapes or distributions may result in some of the layers of the powder bed not being inspected and fused. So in general terms, at least some of the layers of the powder bed are inspected and fused before a next layer is deposited, but not necessarily all.

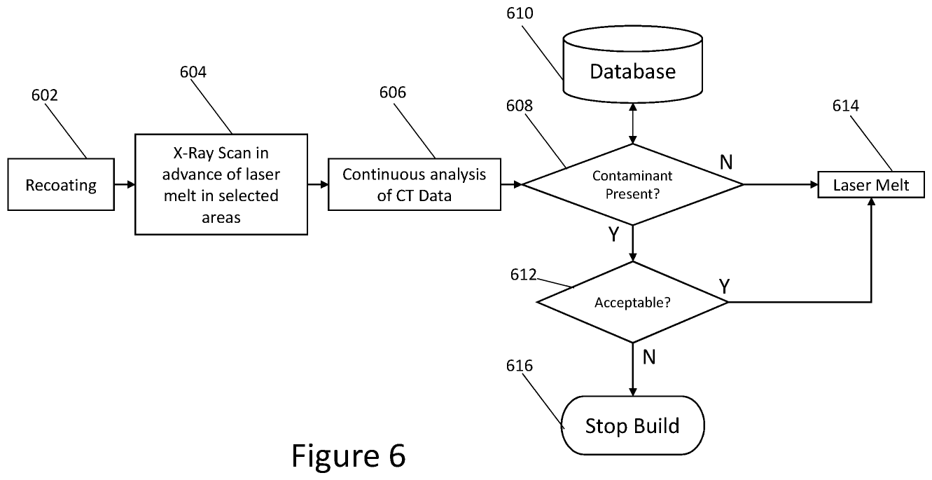

A method of additively manufacturing an object using the apparatus of FIG. 1 is shown in FIG. 6. A layer 115 of powder is deposited in step 602 by the recoater 107. The remaining steps of FIG. 6 are then performed before the next layer in the series is deposited on top of the layer 115. In step 604 the x-ray scan is started. Note that the X-ray scan only inspects selected parts of the layer 115 in accordance with the three-dimensional model of the object, i.e. the islands 114a which are due to be fused by the laser. Unselected parts of the powder of the layer (i.e. the powder between the islands 114a) are not x-ray scanned. This speeds up the inspection process since there is no need to inspect the powder which is not due to be fused. The CT data from the x-ray scan is continuously analysed in step 606 to detect whether or not a contaminant is present in the powder of the layer at step 608.

If no contaminant is detected, then the inspected area is fused in step 614 by the laser in step 614 in accordance with the .STL file once the laser beam reaches it.

If a contaminant is present, then data (for instance size, location, density, material) about the contaminant is logged in a database 610 and the data is analysed in step 612 to determine whether or not the contaminant is acceptable. If the contaminant is acceptable then the process continues as normal so that the contaminant is incorporated into the object by fusing powder to the contaminant in step 614. If the contaminant is not acceptable then the build is stopped at step 616 before the contaminant is incorporated into the object.

The location of the contaminant can be determined by the position and angle of the x-ray source 109 based on the .STL file. The size of the contaminant can be determined by post-processing using voxels to determine the size.

An example of an acceptable contaminant is one which is located at the periphery of an object, so it can be easily machined off in post-processing after the object has been built. Another example of an acceptable contaminant is a particle made of a low density material such as aluminium or a ceramic. The density of the material affects its reflection coefficient, so by measuring the intensity of the reflected x-rays 113 the density of the particle can be inferred, and a decision can be made as to whether it is acceptable.

Once the process of FIG. 6 has been performed for the layer 115, the next layer of powder is deposited on top of it and the process repeats for the next layer.

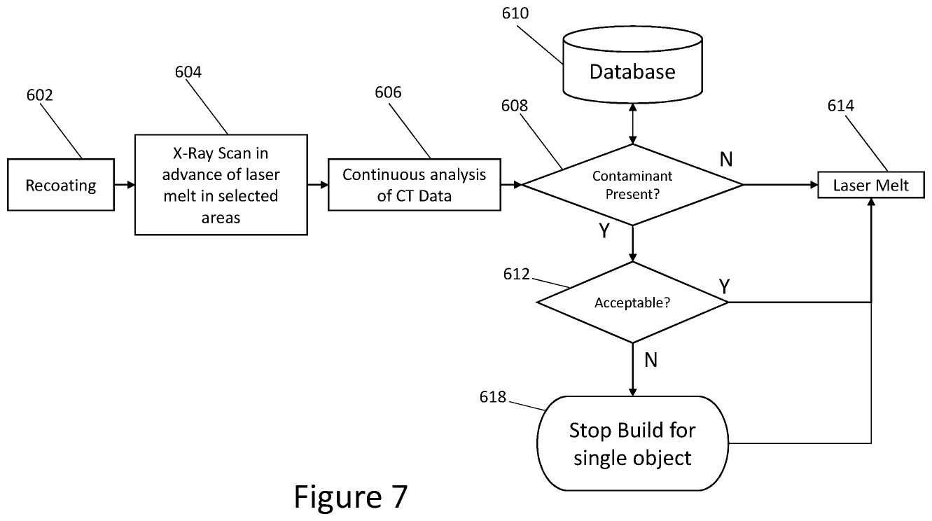

FIG. 7 shows an alternative method which is identical to FIG. 6 except that it applies to the manufacture of multiple objects in a single build, like the six objects shown in FIG. 3. In this case, rather than stopping the entire build process, at step 618 the build for only one of the six objects is stopped before a contaminant is incorporated into the object, and the build for the other five objects continues as normal. At the end of the build process, the unfused powder is recycled and the unfinished object is discarded.

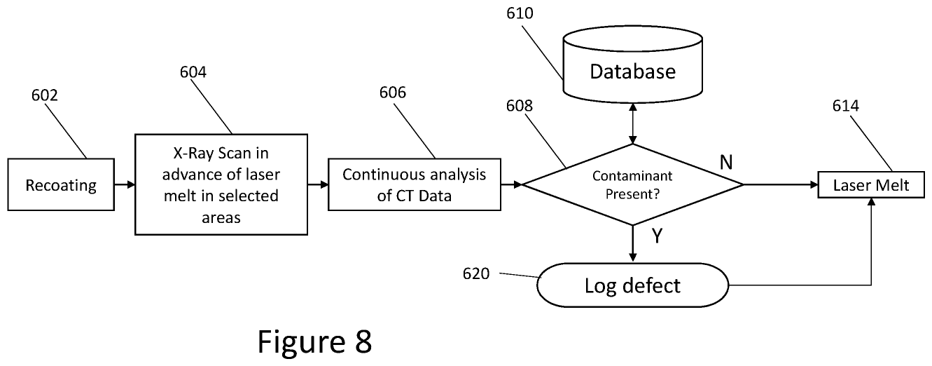

FIG. 8 shows an alternative method which is similar to FIG. 6 but does not result in the build being stopped. In this case, if a contaminant is detected, then data (for instance size, location, density, material) about the contaminant is logged in a database 610 at step 620 then the build continues as normal. Each layer scan is recorded, stacked and aligned in order to create a defect map of the object in the database 610. The detection of the contaminant flags up the need for a detailed CT scan of the object, or other test, to determine whether the object has sufficient mechanical integrity to be used. Some objects may be able to tolerate contaminants in certain non-critical locations.

The methods described above aim to reduce or remove the need for post process non-destructive inspection (NDI) of the objects. Instead of attempting to pass an x-ray completely through the object, x-rays are bounced off the currently exposed layer of the powder bed during each layerwise operation of the process. Much lower energy x-rays are required for reflection and/or scattering, than for complete pass through. The energy required is low and the time required to initiate the x-ray scan would be less compared to set up and scan time for post process NDI. The process enables the detection of defects in the solidified material during the additive process rather than indirect correlation of defects observed on the top surface of the deposition that may or may not disappear during build as the surrounding material gets re-melted. The process detects defects as early as possible in the manufacturing cycle prior to costly post processing steps being carried out on a potentially scrap part.

In the embodiment described above, contaminants are detected by x-ray reflectometry. In an alternative embodiment, back-scattered x-rays may be analysed instead of (or in addition to) reflected x-rays as described in US2018/0126670A1 for example.

Where the word ‘or’ appears this is to be construed to mean ‘and/or’ such that items referred to are not necessarily mutually exclusive and may be used in any appropriate combination.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A method of additively manufacturing an object, the method comprising:
building a powder bed by depositing a series of layers of powder; and
for at least some of the layers and before a next layer in the series is deposited, inspecting the powder of one of the layers by performing an x-ray scan of at least some of the powder of the one of the layers to detect whether or not a contaminant is present in the powder of the one of the layers, and selectively fusing a selected part of the powder of the one of the layers in accordance with a three-dimensional model of the object.

2. The method of claim 1, wherein if the contaminant is detected, then the contaminant is not incorporated into the object.

3. The method of claim 1, wherein if the contaminant is detected, then the contaminant is analysed to determine whether the contaminant is acceptable, and if the contaminant is acceptable then the contaminant is incorporated into the object, and if the contaminant is not acceptable then the contaminant is not incorporated into the object.

4. The method of claim 1, wherein if the contaminant is detected, then the contaminant is analysed to determine whether a location of the contaminant is acceptable, if the location of the contaminant is acceptable then the contaminant is incorporated into the object, and if the location of the contaminant is not acceptable then the contaminant is not incorporated into the object.

5. The method of claim 1, wherein if the contaminant is detected, then data about the contaminant is logged.

6. The method of claim 1, wherein if the contaminant is detected, then a location of the contaminant is logged.

7. The method of claim 1, wherein if the contaminant is detected, then the contaminant is removed in post-processing after the contaminant has been incorporated into the object.

8. The method of claim 1, wherein the inspecting of the powder comprises directing incident x-rays onto at least some of the powder of the layer to generate scattered or reflected x-rays, and analysing the scattered or reflected x-rays to detect whether or not the contaminant is present.

9. The method of claim 1, wherein the inspecting of the powder comprises directing incident x-rays onto at least some of the powder of the layer at an angle of incidence, and analysing x-rays reflected from the powder of the layer at an angle of reflection which is equal and opposite to the angle of incidence to detect whether or not the contaminant is present.

10. The method of claim 1, wherein the inspecting of the powder comprises directing incident x-rays onto at least some of the powder of the layer from an x-ray source to generate scattered or reflected x-rays, receiving the scattered or reflected x-rays from the powder of the layer at an x-ray detector, and analysing the scattered or reflected x-rays received at the x-ray detector to detect whether or not the contaminant is present.

11. The method of claim 10, wherein an intensity of the scattered or reflected x-rays received at the x-ray detector is analysed to detect whether or not the contaminant is present.

12. The method of claim 10, wherein the x-ray source and/or the x-ray detector moves during the x-ray scan.

13. The method of claim 1, wherein the inspecting of the powder of the layer comprises performing the x-ray scan of the selected part of the powder of the layer in accordance with the three-dimensional model of the object to detect whether or not a contaminant is present in the selected part powder of the layer, and wherein unselected parts of the powder of the layer are not x-ray scanned.

14. The method of claim 1, wherein the selected part of the powder of the layer is fused in accordance with the three-dimensional model of the object after the selected part of the powder has been inspected.

15. The method of claim 1, wherein the x-ray scan of the layer is performed over an inspection period, and the selective fusing of the part of the powder of the layer is performed over a fusion period which is partially concurrent with the inspection period.

16. The method of claim 1, wherein the selected part of the powder of the layer is fused by scanning a laser beam across the powder of the layer.

17. The method of claim 1, wherein the selected part of the powder is fused after the selected part has been inspected to detect whether or not the contaminant is present in the selected part of the powder.

18. An apparatus for additively manufacturing an object, the apparatus comprising:
a powder bed build system arranged to build a powder bed by depositing a series of layers of powder;
an x-ray inspection system arranged to perform an x-ray scan of at least some of the powder of at least some of the layers to detect whether or not a contaminant is present in the powder of the layer; and
a powder-fusion system arranged to selectively fuse part of the powder of at least some of the layers in accordance with a three-dimensional model of the object.

19. The apparatus of claim 18, wherein the x-ray inspection system comprises an x-ray source arranged to direct incident x-rays onto the powder of the layer to generate scattered or reflected x-rays, an x-ray detector arranged to receive the scattered or reflected x-rays from the powder of the layer, and a processor arranged to analyse the scattered or reflected x-rays received at the x-ray detector to detect whether or not the contaminant is present in the powder of the layer.

20. An apparatus for additively manufacturing an object, the apparatus comprising:
a powder bed build system comprising a build table, the powder bed build system arranged to build a powder bed by depositing a series of layers of powder on the build table;
a powder-fusion system arranged to selectively fuse part of the powder of at least some of the layers in accordance with a three-dimensional model of the object; and
an x-ray reflectrometry inspection system arranged to inspect the powder bed, the x-ray reflectrometry inspection system comprising an x-ray source arranged to direct incident x-rays onto the powder bed at an oblique angle of incidence to generate reflected x-rays, an x-ray detector positioned to receive the reflected x-rays from the powder bed at an oblique angle of reflection which is equal and opposite to the angle of incidence, and a processor arranged to analyse the reflected x-rays received at the x-ray detector,
wherein the x-ray source is positioned on a first side of the build table, the x-ray detector is positioned on a second side of the build table opposite the first side, and neither the x-ray source nor the x-ray detector is positioned above the build table.
